(19) United States
(12) Patent Application Publication
(10) Pub. No.: US 2010/0314504 A1
(43) Pub. Date: Dec. 16, 2010

(54) Support apparatus for an exhaust system

(75) Inventor: Hugh Thomas Dickinson, Greensboro, NC (US)

Correspondence Address: VOLVO TECHNOLOGY OF AMERICA, CORPORATE PATENTS, 7825 NATIONAL SERVICE ROAD, MAIL STOP, AP1/3-41, GREENSBORO, NC, 27409, US

(73) Assignee: Volvo Group North America, Inc., Greensboro, NC (US)

(21) Appl. No.: 12/456,144

(22) Filed: Jun. 12, 2009

(51) Int. Cl. F16L 3/10

(52) U.S. Cl. 248/74.1; 248/65

(57) ABSTRACT

A support apparatus for an exhaust includes a first bracket mountable to a vehicle cab, a spherical bearing carried by the first bracket, a second bracket mountable to an exhaust pipe, and a rod fixedly mounted to the second bracket and extending through the spherical bearing, the rod being freely movable axially in the spherical bearing, and the spherical bearing allowing the rod to pivot relative to the first bracket.

### FIELD OF THE INVENTION

The invention is directed to an apparatus for supporting an exhaust system of a vehicle, and more particularly, a vertical exhaust stack of a heavy truck.

### BACKGROUND AND SUMMARY

Exhaust stacks in heavy trucks are typically mounted with a base member supported on the truck frame and an upper member attached to the cab. Because the cab is usually mounted by way of a suspension to the truck frame, the cab and frame experience relative movement which must be accommodated by the exhaust stack mounting, which is attached to both.

Exhaust stacks are also subject to vibrations from the hot gas flow and from road induced vibrations transmitted from the frame. These vibrations can be transmitted from the stack to the cab, leading to cab noise and other driver comfort issues.

The invention proposes an exhaust support apparatus that overcomes deficiencies in the art and provides for both relative movement of the exhaust stack and cab and for isolation of the stack vibrations from the cab.

According to the invention, a support apparatus for an exhaust includes a first bracket mountable to a vehicle cab, a spherical bearing carried by the first bracket, a second bracket mountable to an exhaust pipe, and a rod fixedly mounted to the second bracket and extending through the spherical bearing, the rod being freely movable axially in the spherical bearing, and the spherical bearing allowing the rod to pivot relative to the first bracket. A gasket may be included between the first bracket mounting and the cab.

According to another aspect of the invention, the apparatus includes vibration isolating mountings between the rod and the second bracket.

The second bracket may be an integral device mountable to the stack pipe, and may include upper and lower portions for attaching to the opposite ends of the rod. Alternatively, the second bracket may include an upper bracket and a lower bracket each separately mountable to the stack pipe.

The second bracket may include a clamp, such as a band clamp, for mounting to an exhaust pipe.

According to another aspect of the invention, the support apparatus includes a third bracket supporting a bottom end of the exhaust pipe, the third bracket being resiliently mountable to a truck frame for relative pivoting movement. The resilient mounting may comprise elastomeric foot pads between the bracket and the truck frame.

### BRIEF DESCRIPTION OF THE DRAWINGS

The invention will be better understood by reference to the following detailed description read in conjunction with the appended figures, in which:

FIG. 1 is a perspective, section view of a truck, showing an exhaust system mounting support in accordance with the invention;

FIG. 2 is an exploded view of an upper portion of the exhaust system of FIG. 1;

FIG. 3 is an exploded view a cab-to-stack pipe support apparatus;

FIG. 4 is a section view of a truck cab showing a mounting bracket for the cab-to-stack pipe mounting apparatus;

FIG. 5 is an exploded view of a bottom stack pipe mounting bracket; and,

FIG. 6 is an exploded view of a portion of an exhaust system leading from an aftertreatment device to the stack pipe.

### DETAILED DESCRIPTION

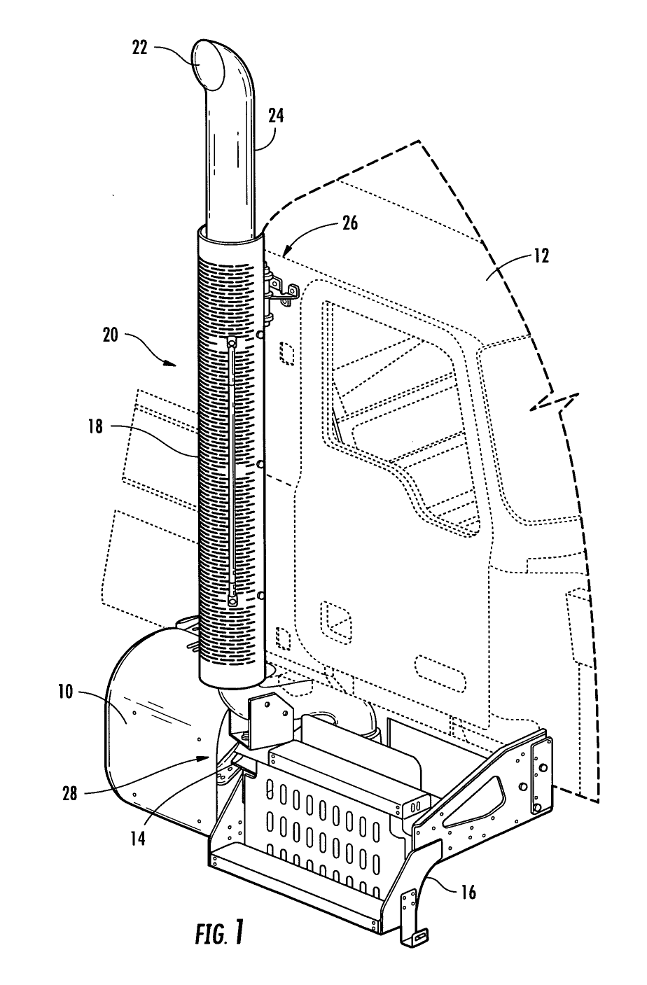

FIG. 1 illustrates an embodiment of a support apparatus for an exhaust system according to the invention supporting an exhaust system 20 on a truck 12. The truck 12 is shown in section. As will be described in more detail below, the exhaust system 20 leads exhaust gas from an aftertreatment device 10 carried on the vehicle frame, for example, a selective catalytic reduction catalyst body, to an outlet 22 of a stack pipe 24. The exhaust system 20 is supported by an upper mounting apparatus 26 connecting the stack pipe 24 to a truck cab 12 and a lower mounting apparatus 28 supporting the exhaust system on the truck frame, here illustrated as a bracket 14 mounted to a frame-carried step assembly 16. A heat 18 shield is mounted in spaced relation to the stack pipe 20.

Turning to FIG. 2, the stack pipe 24 is shown separated from the truck and with the heat shield removed. As may be seen, the stack pipe 24 may be formed in sections, illustrated here are a lower section 30 and an upper section 32 that may be secured by a clamp 34 as is known in the art. The upper mounting apparatus 26 is attached to the stack pipe 24 at a location appropriate for the location selected for mounting to stack pipe the cab (shown in FIG. 1).

FIG. 3 shows an embodiment of the upper mounting apparatus 26 in exploded view. The upper mounting apparatus 26 includes a first bracket 40 which is mountable to the truck cab 12 (FIG. 1), and a second bracket assembly 42 which is mountable to the stack pipe (not illustrated in FIG. 3). Preferably, as shown in FIG. 3, the second bracket assembly 42 includes an upper bracket 44 and a lower bracket 46. Alternatively, the second bracket assembly 42 may include a single bracket, for example, the upper bracket 44. The upper bracket 44 and lower bracket 46, as illustrated, have a generally L-shaped profile, and each includes a flange 48 having a pin mounting hole extending from a cuff 50 formed with a curvature for mating contact with a stack pipe. When mounted on the stack pipe (refer to FIG. 1 and FIG. 2), the flanges 48 are in parallel, spaced relation. A pin or rod 54 is fixedly mounted to the first bracket assembly 42. In the illustrated embodiment, the pin 54 is inserted through the respective pin mounting holes in the flange 48 of the upper bracket 44 and lower bracket 46 and is fixed to each flange 48. The upper bracket 44 and lower bracket 46 are mountable to the stack pipe, which may be done conveniently by a band clamp 60 engaging the cuff 50 and holding it against the stack pipe.

The first bracket 40 in the illustrated embodiment is configured as a plate and carries a spherical bearing 52 which may be secured thereto by bolts 53. The pin 54 extends through the spherical bearing 52 for free sliding movement in the axial direction of the pin. The spherical bearing 52 also allows the pin 54 to pivot relative to the first bracket 40. The combination of sliding and pivoting movement for the pin 54 accommodates relative movement between the stack pipe 24 and the truck cab 12 (FIG. 1).

The pin 54 is mounted to the upper bracket 44 and lower bracket with elastomeric bushings 62 between the pin and the brackets to isolate vibration of the stack pipe from the pin. The ends of the pin 54 are threaded and include shoulders 55 so that the pin can be secured to the upper first plate and lower first plate with threaded fasteners 56.

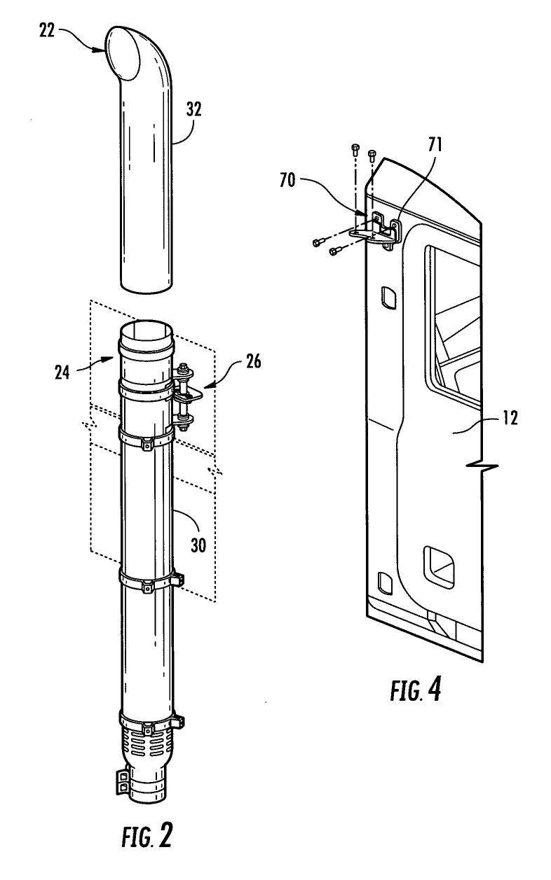

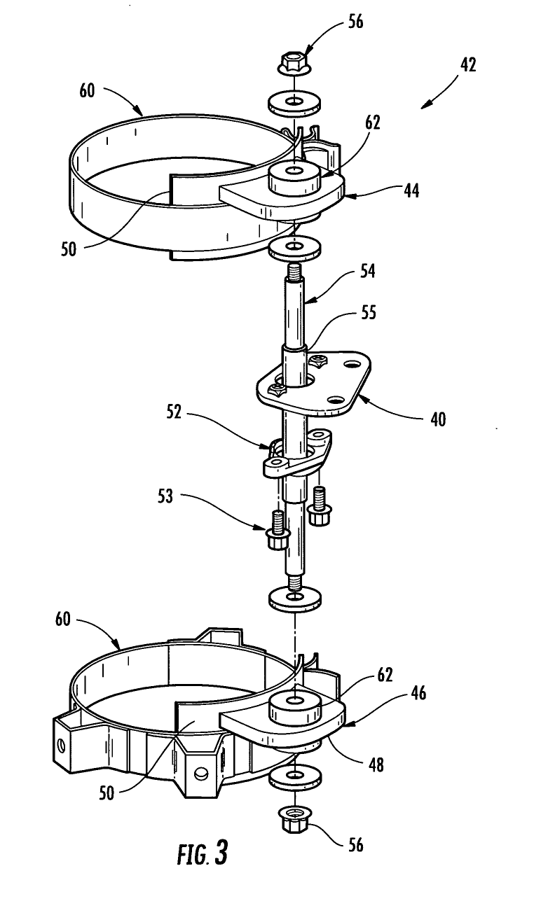

FIG. 4 shows a cab bracket 70 to which the first bracket 40 of the upper support apparatus is mounted. The cab bracket 70 is fastened to the cab 12 and extends outward for mounting the first bracket 40. A gasket 71 is disposed between the bracket 70 and cab 12.

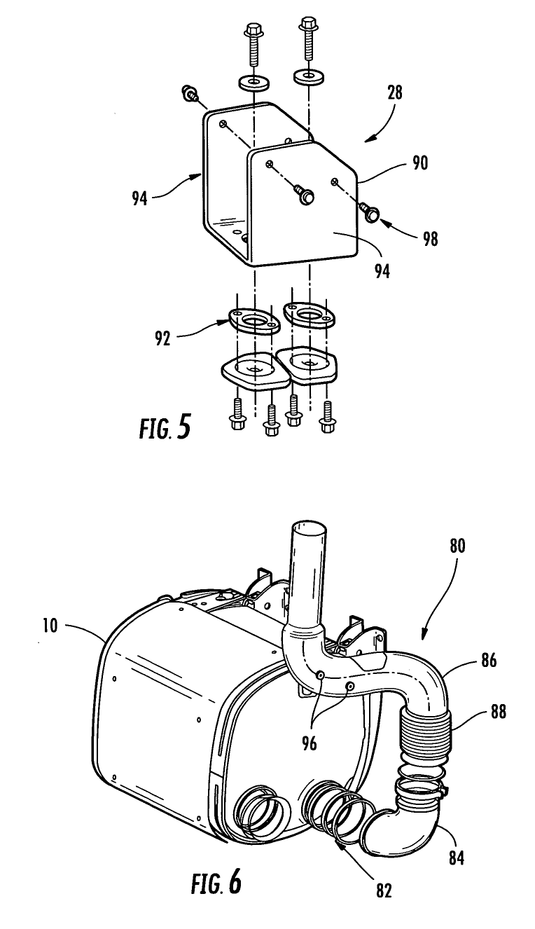

In FIG. 5 and FIG. 6, a lower mounting apparatus 28 and lower exhaust system 80 are illustrated. Turning first to FIG. 6, the lower exhaust system 80 includes an outlet pipe 82 of an exhaust aftertreatment (EAT) device 10. The EAT device outlet pipe 82 is connected to an elbow 84 that turns the exhaust gas flow upward, and which is connected to an S-shaped pipe 86 that leads the gas flow around the step assembly (FIG. 1). The S-shaped pipe 86 connects to the stack pipe 24, as may be seen in FIG. 1. A bellows 88 is installed between the elbow 84 and the S-shaped pipe 86 to isolate the S-shaped pipe from vibration in the elbow.

FIG. 5 shows a lower mounting apparatus 28. The lower mounting apparatus 28 includes a U-shaped bracket 90 and two elastomeric foot pads 92 that support the bottom of the U-shaped bracket. The U-shaped bracket 90 connects to the S-shaped pipe 86 of the exhaust system by an elbow bend of the S-shaped pipe positioned between the upstanding arms 94 of the U-shaped bracket and spaced above the center web of the U-shaped bracket. The S-pipe may be connected, for example, to the U-shaped bracket 90 with threaded fittings 96 (shown in FIG. 6) are attached to or formed on the S-pipe for engaging bolts 98.

The foot pads 92 are formed of elastomeric material with sufficient flexibility and resilience to allow for pivoting movement of the U-shaped bracket, and accordingly, the attached S-pipe 86 and stack pipe 24, relative to the truck frame. This pivot movement complements the pivoting movement the stack pipe 24 permitted by the pin 54 in the spherical bearing 52. In addition, the foot pads 92 provide for isolation of the U-shaped bracket from vibrations in the truck frame.

The invention has been described in terms of preferred principles, embodiments, and structure, however, those skilled in the art will understand that substitutions of described components with equivalents may be made without departing from the scope of the invention as defined by the appended claims.

What is claimed is:

1. A support apparatus for an exhaust pipe, comprising:
a first bracket mountable to a vehicle cab;
a spherical bearing carried by the first bracket system;
a second bracket mountable to an exhaust pipe; and,
a rod fixedly mounted to the second bracket and extending through the spherical bearing, the rod being freely movable axially in the spherical bearing, and the spherical bearing allowing the rod to pivot relative to the first bracket.

2. The support apparatus of claim 1, further comprising vibration isolating mountings between the rod and the second bracket.

3. The support apparatus of claim 1, wherein the second bracket comprises an upper bracket and a lower bracket.

4. The support apparatus of claim 1, further comprising a clamp for mounting the second bracket to an exhaust pipe.

5. The support apparatus of claim 1, further comprising a third bracket supporting a bottom end of the exhaust pipe, the third bracket being resiliently mountable to a truck frame for relative pivoting movement.

6. The support apparatus of claim 5, wherein the third bracket is U-shaped and the bottom end of the exhaust pipe includes an elbow bend mountable between arms of the U-shaped bracket.
